(19) United States
(12) Patent Application Publication
(10) Pub. No.: US 2026/0202039 A1
(43) Pub. Date: Jul. 16, 2026

(54) ROTARY CONTROL DEVICE FOR A COOKER

(71) Applicant: FEREL ELEKTRONIK SAN. VE TIC. A.S., Istanbul (TR)

(72) Inventor: Hasan Bahadir BILGIC, Istanbul (TR)

(73) Assignee: FEREL ELEKTRONIK SAN. VE TIC. A.S., Istanbul (TR)

(21) Appl. No.: 19/156,896

(22) PCT Filed: Feb. 23, 2023
(86) PCT No.: PCT/TR2023/050179

§ 371 Date: Aug. 15, 2025

(51) Int. Cl. F21V 5/00; F21V 7/00; F21W 131/307; F21Y 103/33; F24C 7/08

(52) U.S. Cl. CPC F21V 5/007; F21V 7/0091; F24C 7/082; F21W 2131/307; F21Y 2103/33

(57) ABSTRACT

A rotary control device for a cooker includes a first LED lighting element and at least one second LED lighting element spaced apart from the first LED lighting element, and a lighting plate spaced apart above the first and second LED lighting elements. The control device has a light distributing element that at least partially surrounds the first and second LED lighting elements to disperse the light produced, and the distance between the lighting plate and the light distributing element is adjusted such that the projections of the light produced by the first LED lighting element intersect and reflect off each other.

### CROSS REFERENCE TO THE RELATED APPLICATIONS

This application is the national phase entry of International Application No. PCT/TR2023/050179, filed on Feb. 23, 2023, the entire contents of which are incorporated herein by reference.

### TECHNICAL FIELD

The present invention relates to the illumination of a rotary control device for a household appliance, particularly for a cooker.

### BACKGROUND

In household appliances, especially in cookers, there is a rotary control element that manages the operating functions. For ease of use, the rotary control elements embedded in cookers are illuminated with LED lighting elements. Direct placement of LED lighting elements on the rotary control element can be cumbersome in terms of assembly and leads to a reduction in product life due to increased susceptibility to external factors.

EP3622216A1 relates to a rotary control element designed for a cooker. The invention has a lighting control switch installation containing multiple elements, each of which can be connected to a gas valve corresponding to a burner, contained within a body and sealed with a cover, through which one of the elements passes. On the back of the switch installation, additional light sources, e.g., LEDs carried by a printed circuit board, are observed; a first switch containing at least one fixed contact connected to the printed circuit, a second switch, and a first intermediary that can be connected to a movable shaft of the gas valve integrally. However, the rotation and then the extension of the first and second switches towards each other; and a second key extending towards the first switch includes a second intermediary that can be connected to the valve's shaft and turned parallel to rotate and turn the first and second switches.

### SUMMARY

The object of the invention is to illuminate the rotary control element of a cooker with a small number of illumination elements.

In order to achieve the above objective, the invention relates to a rotary control device for a cooker, including a first LED lighting element and at least one second LED lighting element spaced apart from the first LED lighting element, and a lighting plate provided at a distance above the first and second LED lighting elements. The rotary control device includes a light-distributing element that at least partially surrounds the first and second LED lighting elements to disperse the produced light, and the distance between the lighting plate and the light-distributing element is adjusted so that the projections of the light produced by the first LED lighting element intersect and reflect off each other. This allows the visual transmission of information to the user that the cooker has moved from a closed position to an operating mode.

In a preferred embodiment of the invention, the first LED lighting element is set at a degree angle and spaced apart from the second LED lighting element. This ensures that the produced light affects the maximum impact area and increases the visibility value of the light.

A preferred embodiment of the invention has a third LED lighting element that is spaced apart from the first and second LED lighting elements. This facilitates reaching the level of light visible to the user. In an alternative embodiment, the number of LED lighting elements can be two or four.

In a preferred embodiment of the invention, the light-distributing element includes at least one lens. This allows the produced light to be refracted and dispersed over the lighting plate.

In a preferred embodiment of the invention, the light-distributing element has at least one total internal reflection lens. Thus, by increasing the percentage of light refraction, the area affected is enlarged.

In a preferred embodiment of the invention, the light-distributing element is spaced apart between the first LED lighting element, the second LED lighting element, the third LED lighting element, and the lighting plate. This ensures that the light produced by the three LED lighting elements is evenly distributed by the light-distributing element.

In a preferred embodiment of the invention, the light-distributing element extends directly over the first LED lighting element, the second LED lighting element, and the third LED lighting element. This prevents issues such as shadow casting during illumination as there are no parts in between.

In a preferred embodiment of the invention, the light-distributing element includes corresponding independent lenses, a second lens, and a third lens over the first LED lighting element, the second LED lighting element, and the third LED lighting element. This ensures that the light from each lighting element is evenly dispersed.

In a preferred embodiment of the invention, the lighting plate is semi-transparent. This increases the visibility rate of the user.

In a preferred embodiment of the invention, the lighting plate is set in a ring form. This illuminates the area around a rotary control element placed inside, making it easily visible to the user.

A preferred embodiment of the invention includes a rotary control element provided at the center of the lighting plate. Thus, a structure that provides illumination according to the operating modes of the cooker is obtained.

A preferred application of the invention, includes the steps of turning the rotary control element from a closed position to an open position, activating the LED lighting elements, and reflecting the light scattered from the LED lighting elements through the light distributing element onto itself.

A preferred application of the invention is an oven that has a control device according to the embodiments described above. This ensures that when the control elements of the oven are turned, the lighting plate emits light to the environment, visually transmitting the information that the oven is operating to the user.

### BRIEF DESCRIPTION OF THE DRAWINGS

FIG. 1, a representative side view of the rotary control device according to the invention.

FIG. 2, top view of the light projections on the lighting plate of the rotary control device according to the invention.

FIG. 3, a representative front view of the rotary control device according to the invention.

### DETAILED DESCRIPTION OF THE EMBODIMENTS

In this detailed description, the subject matter of the invention is described with references to examples without any limitation, solely for better understanding.

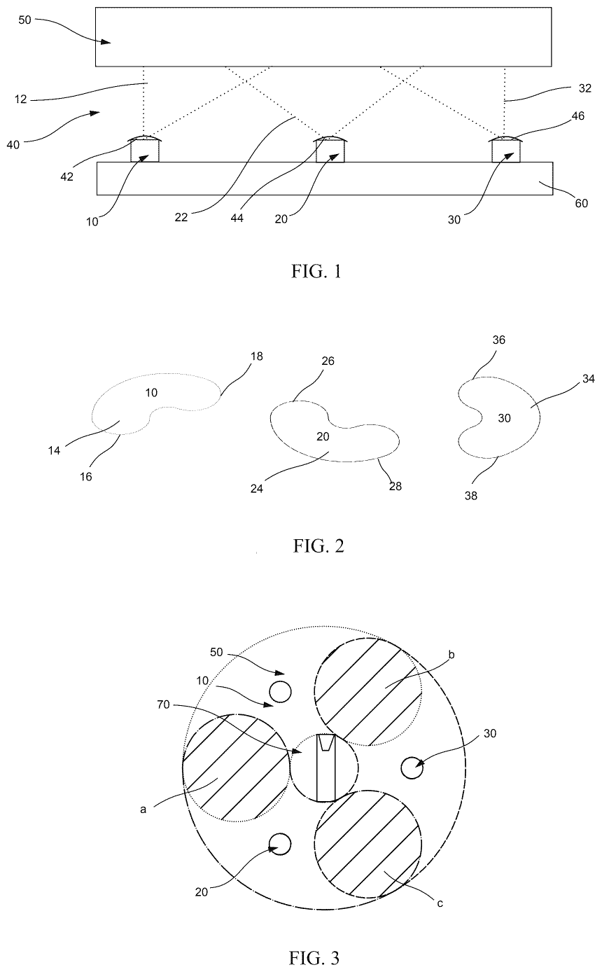

FIG. 1 is a schematic side view of the rotary control device subject to the invention. The rotary control device includes a first LED lighting element (10) positioned on a circuit board (60). A second LED lighting element (20) and a third LED lighting element (30) are located on the circuit board (60), spaced apart from the first LED lighting element (10) at an angle of 120 degrees. The LED lighting elements (10, 20, 30) are equidistant from each other and set at equal angles. A light-distributing element (40) is placed at a distance from the LED lighting elements (10, 20, 30) to disperse the light produced. The light-distributing element (40) includes a lens (42) corresponding to the first LED lighting element (10), a second lens (44) corresponding to the second LED lighting element (20), and a third lens (46) corresponding to the third LED lighting element (30). The lenses (42, 44, 46) disperse the light from the LED lighting elements (10, 20, 30) towards a lighting plate (50). The lenses (42, 44, 46) are preferably used in a convex lens configuration and are chosen as total internal reflection lenses. The lighting plate (50) is made of a semi-transparent material. The light produced by the first lighting element (10) reaches the lighting plate (50) as a first light beam (12) through the lens (42), expanding to fully illuminate a specific area on the lighting plate (50). The light produced by the second lighting element (20) reaches the lighting plate (50) as a second light beam (22) through the second lens (44), expanding to fully illuminate a specific area on the lighting plate (50). The light produced by the third lighting element (30) reaches the lighting plate (50) as a third light beam (32) through the third lens (46), expanding to fully illuminate a specific area on the lighting plate (50).

In FIG. 2, the light projections on the lighting plate of the rotary control device subject to the invention are shown above. The first LED lighting element (10) creates a first light projection area (14) on the lighting plate (50) with the first light beam (12) as shown in FIG. 1, illuminating a region in a particularly bean-like shape between a first end (16) and a second end (18) in an elliptical shape. The second LED lighting element (20) creates a second light projection area (24) on the lighting plate (50) with the second light beam (22) as shown in FIG. 1, illuminating a region in a particularly bean-like shape between a first end (26) and a second end (28) in an elliptical shape. The third LED lighting element (30) creates a third light projection area (34) on the lighting plate (50) with the third light beam (32) as shown in FIG. 1, illuminating a region in a particularly bean-like shape between a first end (36) and a second end (38) in an elliptical shape.

In FIG. 3, a schematic front view of the rotary control device subject to the invention is shown. A rotary control element (70) is located at a central point of the lighting plate (50). By applying a rotational motion to the rotary control element (70), transitioning from a closed position to a working position, the first LED lighting element (10), the second LED lighting element (20), and the third LED lighting element (30) simultaneously enter the working mode, illuminating the lighting plate (50). The first light projection area (14) created by the first LED lighting element (10) on the lighting plate (50) as shown in FIG. 2 intersects with the adjacent second light projection area (24) created by the second LED lighting element (20), forming a first light interference area (a). The first light interference area (a) illuminates the rotary control element (70) without any shadowing. The first light interference area (a) forms a circle-like shape by intersecting the first end (16) of the first light projection area (14) with the first end (26) of the second light projection area (24). The first light projection area (14) created by the first LED lighting element (10) on the lighting plate (50) as shown in FIG. 2 intersects with the adjacent third light projection area (34) created by the third LED lighting element (30), forming a second light interference area (b). The second light interference area (b) illuminates the rotary control element (70) without any shadowing. The second light interference area (b) forms a circle-like shape by intersecting the second end (18) of the first light projection area (14) with the first end (36) of the third light projection area (34). The second light projection area (24) created by the second LED lighting element (20) on the lighting plate (50) as shown in FIG. 2 intersects with the adjacent third light projection area (34) created by the third LED lighting element (30), forming a third light interference area (c). The third light interference area (c) illuminates the rotary control element (70) without any shadowing. The third light interference area (c) forms a circle-like shape by intersecting the second end (28) of the second light projection area (24) with the second end (38) of the third light projection area (34). The first, second, and third light interference areas (a, b, c) provide backlighting in a ring shape for the rotary control element (70).

### REFERENCE NUMBERS

10 First LED Lighting Element
12 First Light Beam
14 First Light Projection Area
16 First End
18 Second End
20 Second LED Lighting Element
22 Second Light Beam
24 Second Light Projection Area
26 First End
28 Second End
30 Third LED Lighting Element
32 Third Light Beam
34 Third Light Projection Area
36 First End
38 Second End
40 Light Distributing Element
42 Lens
44 Second Lens
46 Third Lens
50 Lighting Plate
60 Circuit Board
70 Rotary Control Element
a First Light Interference Area
b Second Light Interference Area
c Third Light Interference Area

What is claimed is:

1. A rotary control device for a cooker, comprising:
a first LED lighting element and a second LED lighting element spaced apart from the first LED lighting element, and
a lighting plate spaced apart above the first LED lighting element and the second LED lighting element;
wherein a light distributing element at least partially surrounds the first LED lighting element and the second LED lighting element to disperse a light produced, and a distance between the lighting plate and the light distributing element is adjusted such that projections of a light produced by the first LED lighting element intersect and reflect off each other.

2. The rotary control device according to claim 1, wherein the first LED lighting element is set at a 120-degree angle and spaced apart from the second LED lighting element.

3. The rotary control device according to claim 2, wherein a third LED lighting element is spaced apart from the first LED lighting element and the second LED lighting element.

4. The rotary control device according to claim 1, wherein the light distributing element has at least one lens.

5. The rotary control device according to claim 4, wherein the light distributing element has at least one total internal reflection lens.

6. The rotary control device according to claim 4, wherein the light distributing element is spaced apart between the first LED lighting element, the second LED lighting element, a third LED lighting element, and the lighting plate.

7. The rotary control device according to claim 4, wherein the light distributing element extends directly over the first LED lighting element, the second LED lighting element, and a third LED lighting element.

8. The rotary control device according to claim 4, wherein the light distributing element comprises a first lens, a second lens, and a third lens independently over the first LED lighting element, the second LED lighting element, and a third LED lighting element.

9. The rotary control device according to claim 1, wherein the lighting plate is semi-transparent.

10. The rotary control device according to claim 9, wherein the lighting plate is set in a ring form.

11. The rotary control device according to claim 10, wherein a rotary control element is provided in a center of the lighting plate.

12. A method of operating the rotary control device according to claim 11, comprising steps of turning the rotary control element from a closed position to an open position, activating the first LED lighting elements, the second LED lighting element, and a third LED lighting element, and reflecting a light scattered from the first LED lighting elements, the second LED lighting element, and the third LED lighting element through the light distributing element onto the first LED lighting element, the second LED lighting element, and the third LED lighting element.

13. An oven comprising the rotary control device according to claim 1.

14. The rotary control device according to claim 2, wherein the light distributing element has at least one lens.

15. The rotary control device according to claim 3, wherein the light distributing element has at least one lens.

16. The rotary control device according to claim 5, wherein the light distributing element is spaced apart between the first LED lighting element, the second LED lighting element, a third LED lighting element, and the lighting plate.

17. The rotary control device according to claim 5, wherein the light distributing element extends directly over the first LED lighting element, the second LED lighting element, and a third LED lighting element.

18. The rotary control device according to claim 6, wherein the light distributing element extends directly over the first LED lighting element, the second LED lighting element, and the third LED lighting element.

19. The rotary control device according to claim 5, wherein the light distributing element comprises a first lens, a second lens, and a third lens independently over the first LED lighting element, the second LED lighting element, and a third LED lighting element.

20. The rotary control device according to claim 6, wherein the light distributing element comprises a first lens, a second lens, and a third lens independently over the first LED lighting element, the second LED lighting element, and the third LED lighting element.
